(19) United States
(12) Patent Application Publication
(10) Pub. No.: US 2009/0201605 A1
(43) Pub. Date: Aug. 13, 2009

(54) VIBRATION-ISOLATING SUPPORT DEVICE

(75) Inventor: Wui-Lun LIN, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/027,875

(22) Filed: Feb. 7, 2008

(51) Int. Cl. G11B 33/14

(52) U.S. Cl. 360/97.02

(57) ABSTRACT

A vibration-isolating support device is used for supporting at least one storage device. The vibration-isolating support device includes a frame to accommodating the storage device, a plurality of elastic washers, and at least two support elements. The frame has at least two side plates, and each side plate is opened with at least one key hole. The elastic washers are disposed in the key holes, so as to absorb vibration energy. At least one first pin is protruded from one side of the support elements, and meanwhile inserted into the elastic washer, such that the support elements are fixed on the side plates and support a bottom surface of the storage device.

### BACKGROUND OF THE INVENTION

1. Field of the Invention

The present invention relates to a support structure of a storage device, and more particularly to a vibration-isolating support device.

2. Related Art

Mostly, at least one non-volatile storage device is configured in a computer, for example, a hard disk and an optical disk drive, so as to store an operating system for executing functions of the computer, and to read and write a large number of data file. Therefore, a fixing device is designed in the case of the computer, for fixing the storage device in the case.

Taking the hard disk for an example, in a conventional hard disk fixing manner, generally, the hard disk is directly locked to a hard disk frame within the case through using a plurality of screws. Alternatively, firstly, two opposite side plates of the hard disk frame are processed through a sheet metal punching process, so as to be bent and formed into a positioning support frame having a folded edge and a fixing base, and thus supporting the hard disk by the positioning support frame. Then, a snapping part is respectively installed on side surfaces of the hard disk, for mutually snapping with the fixing base, such that the hard disk is supported and fixed in the hard disk frame.

Before the snapping part is installed, the machine frame must be firstly processed to be folded vertically to reach the positioning support frame and the fixing base of the side plate. Since the support frame and the fixing base are directly formed on the side plate in a hollow manner, similar to the conventional locking manner of locking the hard disk device, the above two manners both may cause that the machine frame only has a utilizing space on one side, but the other side of the side plate cannot be utilized to lock and fix additional storage devices. As for a working station having a plurality of hard disks, such as a server, a plurality of machine frames must be additionally disposed for placing a great number of hard disks, such that the machine frames of the computer occupy too much space.

In order to have certain structural strength, the hard disk frame for fixing the hard disk is mostly made of rigid materials, and directly fixed within the case. The conventional storage devices, such as hard disks or optical disk drives, directly contact with and are fixed on the hard disk frame. If the computer is suddenly crashed down or even falls off onto the ground by accident, a crashing force borne by the hard disk frame will be directly transferred to the storage device, such that the storage device is extremely easily damaged, and even destroyed.

In addition, vibrations generated when a heat sink fan is operated within the computer device are transferred to the hard disk frame, and additionally, the storage device generates micro-vibration energies during operation, both the above two vibrations extremely easily generate a resonance effect with the hard disk frame. Under the synergistic effect together with a resonance frequency in an inner space of the computer, the generated resonance noises are rather severe. Furthermore, the storage device is easily damaged because of the resonance of the machine frame, which may further shorten the service life of the storage device.

### SUMMARY OF THE INVENTION

The conventional frame for fixing the storage device is lack of a buffering effect, and as a result, the storage devices are easily damaged due to being vibrated, and meanwhile, the design of the frame structure is not suitable for the storage devices to be disposed therein in parallel. In view of the above problems, the present invention provides a vibration-isolating support device, which not only increases a space available for the machine frame of the computer, but also absorbs the vibration energy, so as to prevent the storage device from being damaged.

A vibration-isolating support device, of the present invention is used for supporting at least one storage device, which includes a frame, a plurality of elastic washers, and at least two support elements. The frame is used to accommodate the storage device and has a plurality of side plates. Each side plate is opened with at least one key hole. The elastic washers are disposed within the key holes, so as to absorb and isolate vibration energy, and each elastic washer has a sleeve hole. Each support element has at least one first pin protruded from one side thereof and inserted into the sleeve hole of the elastic washer, such that each support element is fixed on each opposite side plate and supports a bottom surface of the storage device.

The advantage of the present invention lies in that, the key holes are respectively formed on the two opposite side surfaces of the side plate for the frame in advance, the elastic washers for absorbing the vibration energy are installed within the key holes, and at least two support elements are fixed on the two opposite side surfaces of the side plate through the elastic washers, so as to form a plurality of spaces for supporting and accommodating the storage devices. In this way, not only the available space in the frame is increased, but also the elastic washers further provide a vibrate energy absorption effect, so as to protect the storage devices from being affected by the vibration energy.

### BRIEF DESCRIPTION OF THE DRAWINGS

The present invention will become more fully understood from the detailed description given herein below for illustration only, which thus is not limitative of the present invention, and wherein:

FIG. 1 is an exploded view of a first embodiment of the present invention;

FIG. 2 is a perspective view of the first embodiment of the present invention;

FIG. 3 is a cross-sectional view of the first embodiment of the present invention;

FIG. 4 is an exploded view of a second embodiment of the present invention;

FIG. 5 is a perspective view of the second embodiment of the present invention;

FIG. 6 is a cross-sectional view of the second embodiment of the present invention; and

FIG. 7 is a cross-sectional view of a third embodiment of the present invention.

### DETAILED DESCRIPTION OF THE INVENTION

The vibration-isolating support device of the present invention is used to supporting one or more storage devices which likes a non-volatile storage devices fixed within the case of the computer, such as hard disk drives, soft disk drives, optical disk drives, recorders, but not limit to the above-mentioned computer devices. In the following detailed description of the present invention, the hard disk drive is taken as the most preferred embodiment of the present invention. However, the accompanying drawings are only provided for making references and illustrations, but not to limit the present invention.

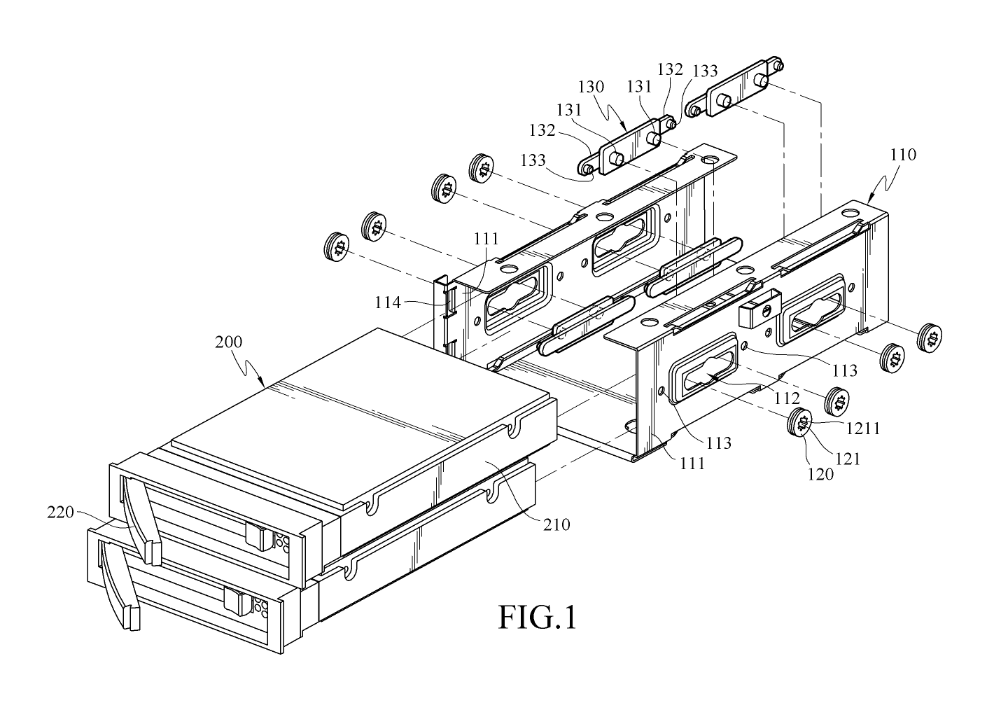

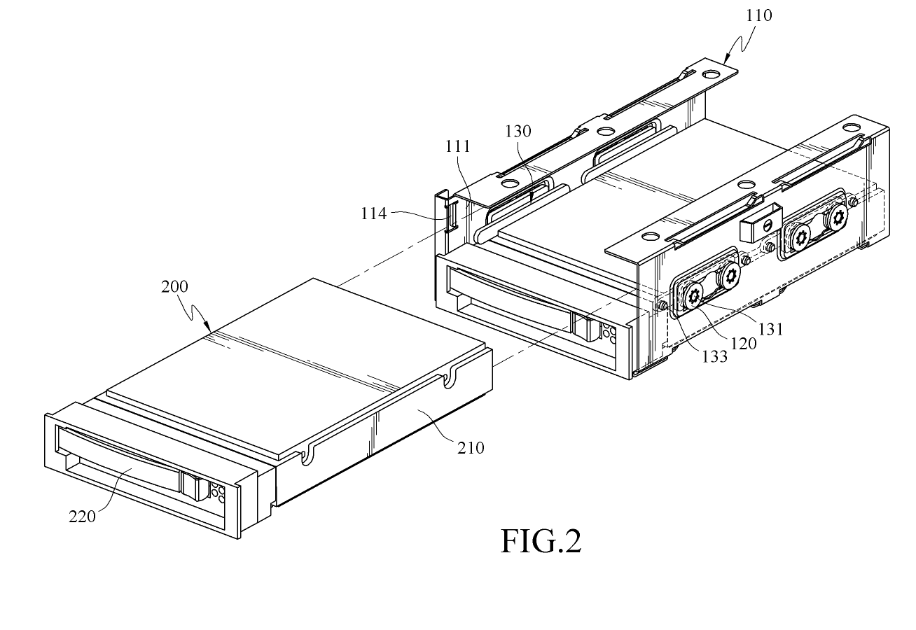

FIGS. 1 and 2 are schematic views of a first embodiment of the present invention. The vibration-isolating support device of the present invention is used to support one or more storage devices 200. The support device includes a frame 110, a plurality of elastic washers 120, and at least two support elements 130. The frame 110 has two opposite side plates 111, and they are spaced apart to form an accommodation space with an equal width as the storage device 200, which is provided for the storage device 200 to be accommodated between the two side plates 111. At least one key hole 112 is respectively opened on the two side plates 111, and the key holes 112 have a fixed gap between each other, and they are corresponding to the size of the storage device 200. The elastic washers 120 are disposed into the key holes 112 in pairs, and a sleeve hole 121 is respectively disposed at a central position of each elastic washer 120.

Two first pins 131 are protruded at one side of each support body 130 and meanwhile inserted into the sleeve holes 121 of the elastic washers 120 respectively, such that the support elements 130 are respectively fixed on side surfaces of the two side plates 111 that are facing each other. In addition, a plurality of support elements 130 spaced apart from each other may be disposed along a longitudinal direction depending upon the actual number of the storage devices 200, such that an appropriate space just for accommodating a single storage device 200 is formed between the upper and lower neighboring support elements 130. Once the storage device 200 is placed between the two side plates 111, the two opposite support elements 130 appropriately support the bottom surface of the storage device 200 from two sides of the storage device 200.

Please refer to FIGS. 1 and 2, an arc-shaped guide portion 132 is respectively extended from two ends of the support element 130, and has a second pin 133 on one side facing the side plate 111. The second pin 133 is embedded into the through hole 113 of the frame 110, such that the support element 130 is fixed on the side plate 111, and it is not easily loosened.

If some deviation occurs to a position or an angle for the storage device 200 to be pushed into the frame 110, the arc-shaped guide portion 132 guides slide rails 210 on two sides of the storage device 200 to smoothly slide towards a position above the support element 130, such that the support element 130 supports the storage device 200 in the accommodation space formed by the two side plates 111, and meanwhile, a fixing unit 220 pivoted to one end of the storage device 200 is buckled with a positioning hole 114 on the edge of the side plate 111, thereby fixing the storage device 200 in the frame 110.

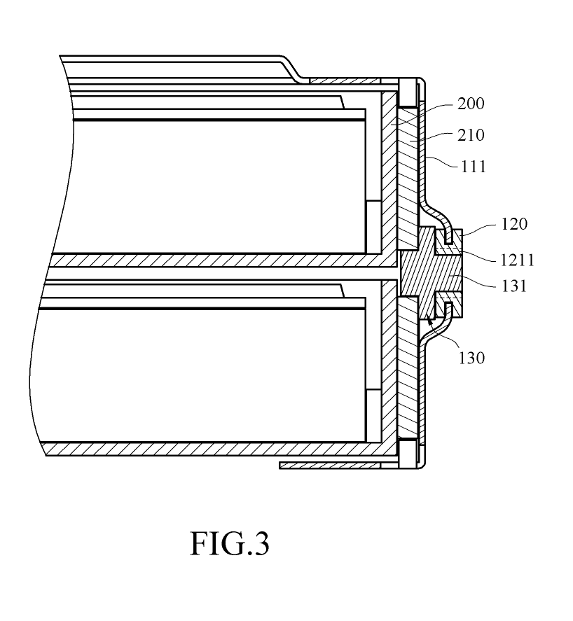

Referring to FIG. 3, the elastic washers 120 installed in the key holes 112 are used to absorb the vibration energy transferred from the exterior to the storage device 200 (e.g., crashes from the exterior or vibrations generated by the heat sink fan during operation), or to absorb the vibration energy generated by the storage device 200 during operation. A plurality of vibrate-absorbing portions 1211 is protruded at a periphery of the elastic washer 120, and contacts with the first pin 131 of the support element 130, so as to prevent the storage device 200 from directly contacting with the side plate 111. In this way, the vibration energy to be absorbed must firstly pass through the elastic washer 120 before being delivered to the side plate 111 and the storage device 200, and thereby improving the vibrate isolation and vibrate absorption effects of the elastic washer 120.

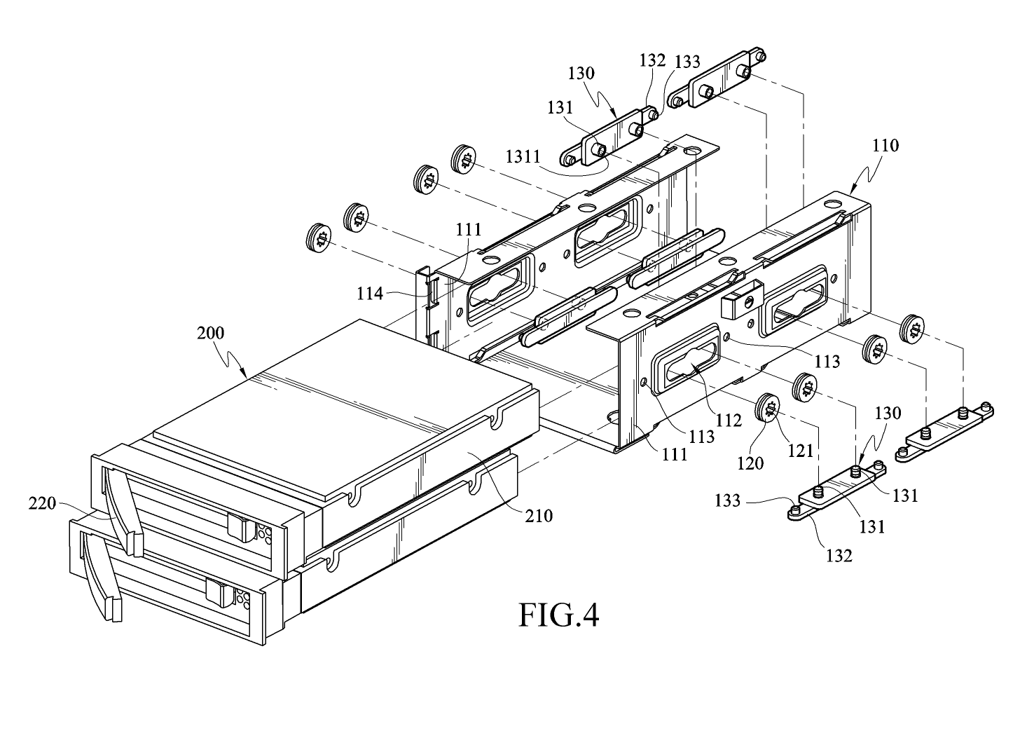

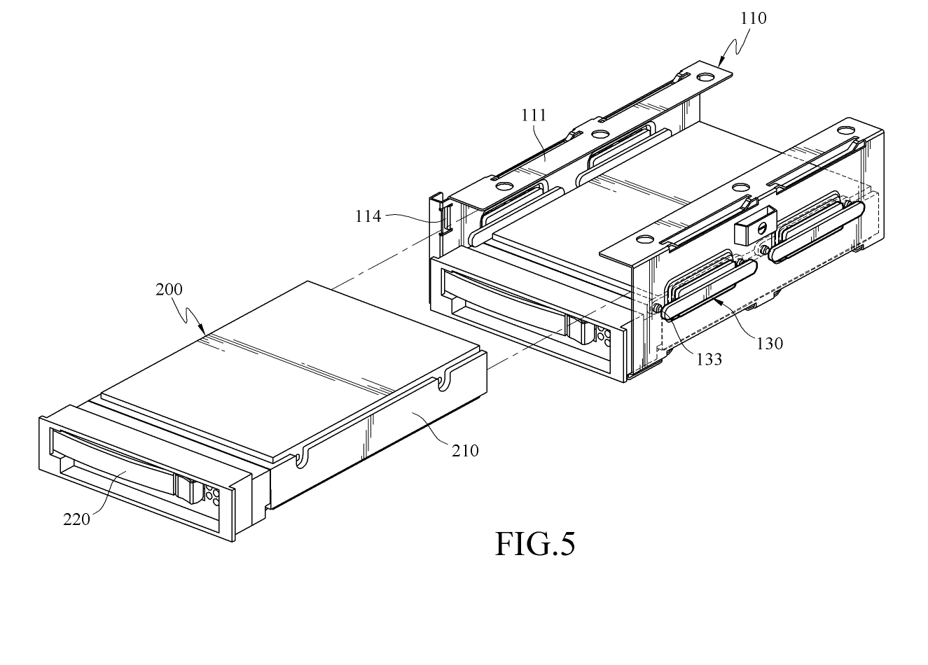

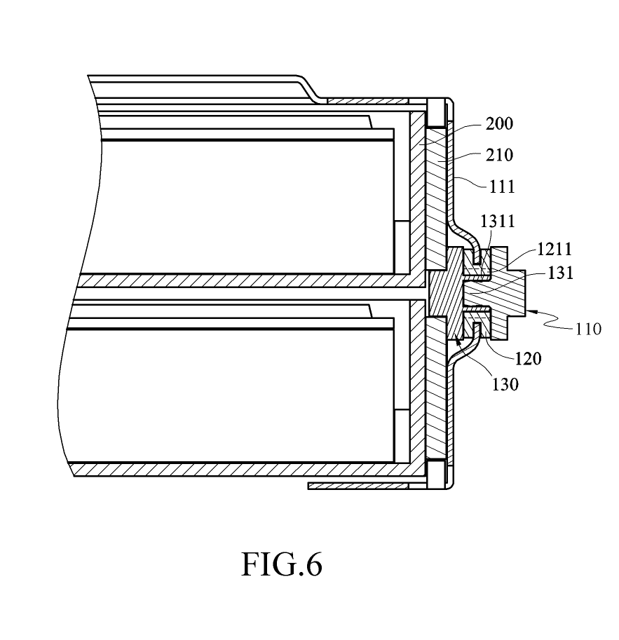

FIGS. 4 to 6 show a vibration-isolating support device according to a second embodiment of the present invention. The support elements 130 in the second embodiment of the present invention may be configured in pairs to further form a support part, and they are respectively inserted into the elastic washer 120 on the side plate 111, such that the two support elements 130 are respectively disposed on two opposite side surfaces of the side plate 111. The first pin 131 of one of the support elements 130 has an insert hole 1311, and the first pin 131 of the other support element 130 is embedded into the insert hole 1311 in the sleeve hole 121 of the elastic washer 120, such that the two support elements 130 are fixed on the same side plate 111.

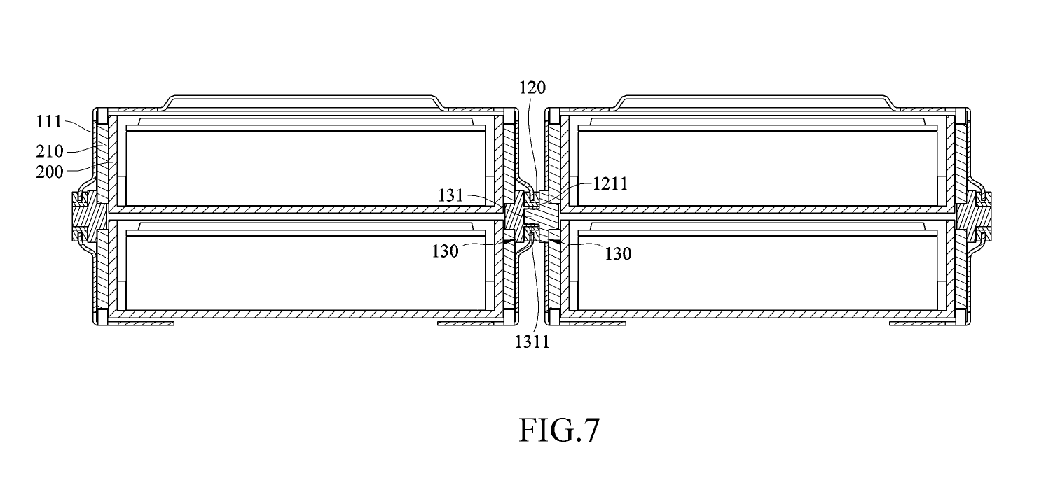

FIG. 7 is a cross-sectional view of a third embodiment of the present invention. As shown in FIG. 7, the vibration-isolating support device of the present invention is used to supporting a plurality of storage devices 200. The vibration-isolating support device in the third embodiment includes a frame 110, a plurality of elastic washers 120, and a plurality of sets of support elements 130 configured in pairs. The frame 110 has a plurality of side plates 111 spaced apart by a fixed gap to form a plurality of accommodation spaces with an equal width as the storage devices 200. At least one key hole 112 is respectively opened on each side plate 111, and the key holes 112 are spaced apart from each other by a fixed gap, and a plurality of sets of key holes 112 is opened corresponding to the size of the storage devices 200. The elastic washers 120 are disposed in pairs in the key holes 112, and a sleeve hole 121 is disposed at a central position of the elastic washer 120.

Referring to FIG. 7, in each set of support elements 130 disposed in pairs, two first pins 131 are protruded from one side of one of the support elements 130, and the two first pins 131 have insert holes 1311. Two first pins 131 are also protruded from one side of the other corresponding support element 130. The support elements 130 arranged in pairs are respectively disposed on two opposite side surfaces of the side plate 111. The first pins 131 are respectively inserted into the sleeve holes 121 of the elastic washers 120. The first pins 131 of the two support elements 130 are embedded into the insert holes 1311 of the other pins 131 in the sleeve hole 121, such that the two support elements 130 share one elastic washer, and they are fixed at the same horizontal position of the same side plate 111.

A single support element 130 may be selectively installed on the side plate 111 at the edge of the frame 110, or two support elements 130 arranged in pairs are respectively installed on the two opposite side surfaces of the side plate 111, which is not limited in this embodiment. Once the storage device 200 is placed between two neighboring side plates 111, the support body 130 located at the two opposite side plates 111 can appropriately support the bottom surface of the storage device 200 from two sides of the storage device 200. In this way, the vibration energy transferred from the exterior to the frame 110 or the vibration energy generated by the storage devices 200 themselves are absorbed by the elastic washer 120.

In the vibration-isolating support device provided by the present invention, a plurality of key holes at different heights is opened on the side plates of the frame in advance, which is provided for the plurality of elastic washers to be installed therein, and the plurality of support elements is embedded on the side plates, so as to form a plurality of spaces for supporting and accommodating the storage devices, such that a plurality of storage devices may be fixed at an equal height between two opposite side surfaces of the side plate in the frame. Not only the available space in the frame is increased, but also the elastic washers further provide a vibrate absorption effect, so as to protect the storage device installed within the frame from being affected by the vibration energy and thus being damaged.

What is claimed is:

1. A vibration-isolating support device, for supporting at least one storage device, comprising:
a frame, having two opposite side plates, wherein the two side plates are opened with at least one key hole, and the storage device is accommodated between the two side plates;
a plurality of elastic washers, respectively disposed in the key holes, and each having a sleeve hole; and
at least two support elements, having at least one first pin protruded from one side thereof and inserted into the sleeve hole, such that the two support elements are respectively fixed on the two side plates and support a bottom surface of the storage device.

2. The vibration-isolating support device as claimed in claim 1, wherein the sleeve hole has a plurality of vibrate-absorbing portions protruded at a periphery thereof.

3. The vibration-isolating support device as claimed in claim 1, wherein the support element has an arc-shaped guide portion respectively extending from two ends thereof.

4. The vibration-isolating support device as claimed in claim 3, wherein the two guide portions respectively have a second pin, the frame has two through holes, and the two second pins are embedded in the two through holes, such that the support element is fixed on the side plate.

5. A vibration-isolating support device, for supporting at least one storage device, comprising:
a frame, having a plurality of side plates spaced apart from one another to form a plurality of accommodation spaces with an equal width as the storage device, wherein each of the side plates is opened with at least one key hole, and the storage device is accommodated between two opposite side plates;
a plurality of elastic washers, arranged in pairs and respectively disposed in the key holes, and each having a sleeve hole; and
a plurality of support parts, having a plurality of first pins inserted into the sleeve holes, such that the support parts are respectively fixed on the side plate and support a bottom surface of the storage device.

6. The vibration-isolating support device as claimed in claim 5, wherein the sleeve hole has a plurality of vibrate-absorbing portions protruded at a periphery thereof.

7. The vibration-isolating support device as claimed in claim 5, wherein the support part has two support elements respectively disposed on two opposite side surfaces of the side plate; each support element has two first pins protruded at one side thereof, and the two first pins are respectively inserted into the sleeve holes and mutually embedded therein.

8. The vibration-isolating support device as claimed in claim 7, wherein each first pin of one support element for the support part has an insert hole for each first pin of the other support element to be embedded therein, such that each support element is respectively fixed on two opposite side surfaces of the side plate.

9. The vibration-isolating support device as claimed in claim 7, wherein the support element has an arc-shaped guide portion respectively extending from two ends thereof.

10. The vibration-isolating support device as claimed in claim 9, wherein each of the two guide portion has a second pin, and the frame has two through holes for the two second pins to be embedded therein, such that the support element is fixed on the side plate.
